(19) United States
(12) Patent Application Publication
(10) Pub. No.: US 2022/0252480 A1
(43) Pub. Date: Aug. 11, 2022

(54) CHART FOR TESTING RESOLUTION OF WIDE-ANGLE LENS AND METHOD FOR TESTING RESOLUTION

(71) Applicant: HON HAI PRECISION INDUSTRY CO., LTD., New Taipei (TW)

(72) Inventors: Po-Chou Chen, Tu-Cheng (TW); Chun-Cheng Ko, New Taipei (TW)

(21) Appl. No.: 17/584,728

(22) Filed: Jan. 26, 2022

(30) Foreign Application Priority Data
Feb. 9, 2021 (CN) 202110178243.4

(51) Int. Cl. G01M 11/02; G03B 43/00; G06T 7/00; G02B 13/04

(52) U.S. Cl. CPC G01M 11/0264; G02B 13/04; G06T 7/0002; G03B 43/00

(57) ABSTRACT

A test chart which is used in a method for testing resolution of a wide-angle lens includes a test area, first patterns, and second patterns. The test area has a center point, and first and second diagonal lines intersecting at the center point. The first and second patterns are arranged around the center point and located on the first and second diagonal lines. Each of the second patterns comprises first to fourth points successively connected by curves with curvature positively related to a distortion value in relation to the wide-angle lens under test. By designing the test area, the first patterns, and the second patterns, a deformation of the first and second patterns in a captured image can be eliminated. The method for testing resolution using the test chart is also disclosed.

### FIELD

The subject matter relates to manufacturing, and more particularly, to a test chart for resolution of imaging, and a method for testing resolution of a wide-angle lens using the test chart.

### BACKGROUND

Since wide-angle lenses have a large field of view, camera modules with wide-angle lenses have been widely used in electronic products. In order to meet the performance requirements of the camera modules, the camera modules need to be tested for resolution and other conditions before leaving the factory. The method for testing resolution generally includes a method for testing spatial frequency response (SFR), a method for testing modulation transfer function (MTF), or a method for testing contrast transfer function (CTF). Among them, the method for testing SFR needs to use a test chart.

The test chart generally includes several patterns. For an imaging lens with zero or small distortion, an image of the patterns of the test chart when captured would scale down. However, for a wide-angle lens, distortion will cause the image of the patterns of the test chart to be distorted in capture, which affects the calculation of resolution.

### BRIEF DESCRIPTION OF THE DRAWINGS

Implementations of the present technology will now be described, by way of example only, with reference to the attached figures.

FIG. 1 is a diagrammatic view of an embodiment of a test chart according to the present disclosure.

FIG. 2 is a diagram view of another embodiment of a test chart according to the present disclosure.

FIG. 3 is a flowchart of a method for testing resolution of a wide-angle lens using a test chart according to the present disclosure.

### DETAILED DESCRIPTION

Technical solutions of the present disclosure will be described in detail with reference to the drawings. Same or similar labels indicate same or similar elements or elements with same or similar functions. The embodiments described below with reference to the drawings are illustrative and only for explanation purposes, and should not be constructed as limiting the present disclosure.

It should be noted that orientations or positional relationships indicated by terms “center,” “longitudinal,” “transverse,” “length,” “width,” “thickness,” “upper,” “lower,” “front,” “back,” “left,” “right,” “vertical,” “horizontal,” “top,” “bottom,” “inner,” “outer,” “clockwise,” “counterclockwise,” etc. are based on the orientations or positional relationships shown in the drawings, and are only for the convenience of describing the disclosure and simplifying the description, rather than indicating or implying that a device or an element referred to must have a specific orientation or must be constructed and operated in a specific orientation, and therefore should not be understood as a limitation to the present disclosure. In addition, terms “first” and “second” are only for descriptive purposes and should not be understood as indicating or implying a relative importance or implicitly indicating the number of a technical feature indicated. A feature being defined as “first” and “second” may explicitly or implicitly include one or more of the feature. In the description of the present disclosure, the term “plurality” refers to two or more, unless otherwise specifically defined.

It should be noted that, unless otherwise clearly specified and defined, terms “dispose,” “combine,” “connect,” and “connection” should be understood in a broad sense. For example, they can indicate a fixed connection, a detachable connection, or an integral connection. They can indicate a mechanical connection, an electrical connection, or being able to communicate with each other. They can indicate a direct connection or an indirect connection through an intermediary. Then can indicate a connection between two components or an interaction between two components. For those having ordinary skills in the art, specific indications of the terms in the present disclosure can be understood according to specific situations.

In the present disclosure, unless otherwise clearly specified and defined, a first feature being “above” or “below” a second feature may include a direct contact of the first and second features, or may include no direct contact but a contact through other features in between. Further, the first feature being “above” the second feature includes the first feature being directly above or obliquely above the second feature, as well as indicating that the first feature is higher in level than the second feature. The first feature being “below” the second feature includes the first feature being directly below or obliquely below the second feature, or only indicates that the first feature is lower in level than the second feature.

This specification provides many different embodiments or examples for realizing different structures of the present disclosure. In order to simplify the description of the present disclosure, components and settings of specific examples are described below. They are merely examples and are not intpointed to limit the disclosure. In addition, the present disclosure may repeat a reference number and/or a reference letter in different examples for a purpose of simplification and clarity, which does not indicate a relationship between embodiments and settings described. Other embodiments conceived by those having ordinary skills in the art on the basis of the described embodiments without inventive efforts should fall within the scope of the present disclosure.

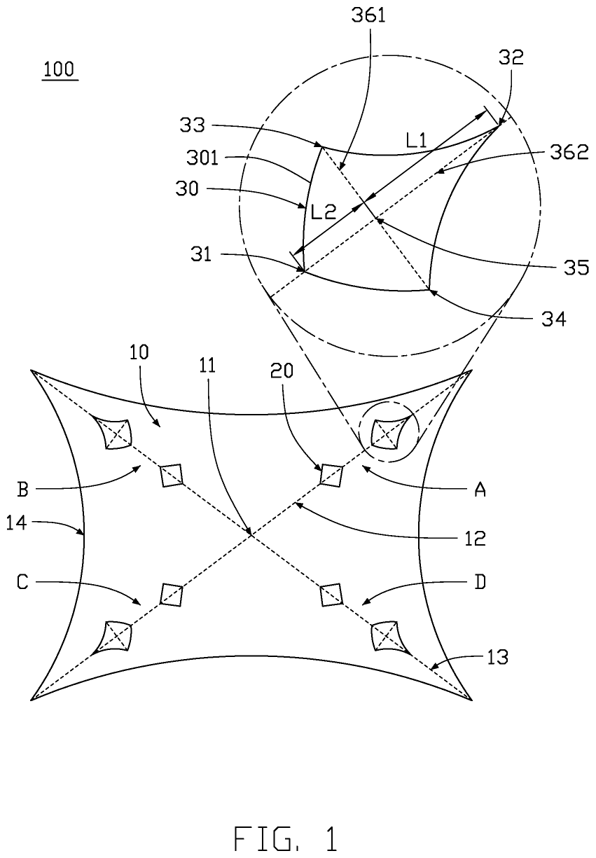

As shown in FIG. 1, a test chart 100 for testing resolution of a wide-angle lens includes a test area 10, a plurality of first patterns 20, and a plurality of second patterns 30. The first patterns 20 and the second patterns 30 are arranged in the test area 10.

The test area 10 is substantially axisymmetric, and has a center point 11, a first diagonal line 12, and a second diagonal line 13. The first diagonal line 12 and the second diagonal line 13 intersect at the center point 11.

The first patterns 20 are arranged around the center point 11 of the test area 10 and are located on the first diagonal line 12 and the second diagonal line 13.

The second patterns 30 are also arranged around the center point 11 of the test area 10 and are located on the first diagonal line 12 and the second diagonal line 13. Each of the second patterns 30 is located on a side of one of the first patterns 20 but further away from the center point 11. Specifically, each of the second patterns 30 on the first diagonal line 12 is located on a side, away from the center point 11, of an adjacent first pattern 20 which is also on the first diagonal line 12. Each of the second patterns 30 on the second diagonal line 13 is located on a side, away from the center point 11, of an adjacent first pattern 20 which is also on the second diagonal line 13. Each of the second patterns 30 has a first point 31 and a second point 32 which are on the first diagonal line 12 or the second diagonal line 13 and a third point 33 and a fourth point 34 which are on opposite sides of the first diagonal line 12 or the second diagonal line 13. The second point 32 is located on a side of the first point 31 away from the center point 11. The first to fourth points 31-34 are successively connected by a plurality of curves 301. In other words, the ends of the first to fourth points 31-34 are connected. The curves 301 form a contour of the second pattern 30. The curvature of each of the curves 301 is positively related to a distortion value in relation to the wide-angle lens.

In the test area 10, the contours of the second patterns 30 are positively related to the distortion value in relation to the wide-angle lens, which overcomes the deformation of the first and second patterns 20 and 30 of the test chart 100 in a captured image caused by the distortion of the wide-angle lens, so that the first and second patterns 20 and 30 of the test chart 100 in the captured image remain unchanged while testing the resolution of the wide-angle lens, which improves the test accuracy of the resolution of the wide-angle lens.

In one embodiment, the test area 10 is quadrilateral in shape, four sides of the quadrilateral are four boundary lines 14 of the test area 10. The four boundary lines 14 can also be understood as edges of an effective capture area of an image of the test chart 100 obtained from the wide-angle lens. The four boundary lines 14 of the test area 10 are concave relative to the center point 11, which is beneficial to non-deformation of the first and second patterns 20 and 30 of the test chart 100 in the captured image of, improving the test accuracy of the resolution of the wide-angle lens.

In one embodiment, the test area 10 can be displayed on a paper, a screen, a projection base plate, or other carrier. A fill color of the test area 10 can be white, and fill colors of the first patterns 20 and the second patterns 30 can be black. Alternatively, the fill color of the test area 10 can be white, the fill color of the first patterns 20 can be green, and the fill color of the second patterns 30 can be red.

In other embodiments, the fill colors of the test area 10, the first patterns 20, and the second patterns 30 can be other colors. It should be noted that, the fill colors of the first patterns 20 and the second patterns 30 should be different from the fill color of the test area 10, and the fill color of the first patterns 20 and the fill color of the second patterns 30 can be the same or different.

In one embodiment, the number of the first patterns 20 is four, the four first patterns 20 are arranged around the center point 11 and respectively located on the first diagonal line 12 and the second diagonal line 13. Specifically, two of the four first patterns 20 are located on the first diagonal line 12 and take the center point 11 as a point of symmetry, and the other two of the four first patterns 20 are located on the second diagonal line 13 and take the center point 11 as the point of symmetry.

The number of the second patterns 30 is four, and the four second patterns 30 are arranged around the center point 11 and respectively located on the first diagonal line 12 and the second diagonal line 13. Specifically, two of the four second patterns 30 are arranged on the first diagonal line 12 and take the center point 11 as the point of symmetry, and the other two of the four second patterns 30 are arranged on the second diagonal line 13 and take the center point 11 as the point of symmetry. Each of the four second patterns 30 is located on a side of one first pattern 20 away from the center point 11.

In other embodiments, the numbers of the first patterns 20 and the second patterns 30 can be more or less, for example, the numbers of the first patterns 20 and the second patterns 30 can be two, three, five, or more. It should be noted that the number of the first patterns 20 and the number of the second patterns 30 are preferably the same. On different portions of the first diagonal line 12 and the second diagonal line 13 on different sides of the center point 11, the number of the first patterns 20 and the number of the second patterns 30 are the same. For example, the number of the first patterns 20 is two and the number of the second patterns 30 is two, one of the two first patterns 20 and one of the two second patterns 30 are arranged on an A area which is a portion of the first diagonal line 12 on a side of the center point 11, the other one of the two first patterns 20 and the other one of the two second patterns 30 are arranged on a B area which is a portion of the second diagonal line 13 on a side of the center point 11, on a C area which is the other portion of the first diagonal line 12 on the other side of the center point 11, or on a D area which is the other portion of the second diagonal lien 13 on the other side of the center point 11.

The shapes of the second patterns 30 in the A to D areas can be the same. The shape of one second pattern 30 in the A area is described in detail below.

Specifically, the second pattern 30 includes the first point 31 and the second point 32 which are on the first diagonal line 12 and the third point 33 and the fourth point 34 which are on the opposite sides of the first diagonal line 12. The second point 32 is located on the side of the first point 31 away from the center point 11. The first to fourth points 31-34 are successively connected by the curves 301 with the curvature positively relating to the distortion value of the wide-angle lens.

A manufactured wide-angle lens will have a distortion value, and different wide-angle lenses have different distortion values. The distortion value σ is determined by: σ=(H−h)/h, where H is an actual image height, and h is a paraxial image height.

In this embodiment, the curvature of the curves 301 is c, the distortion value is σ, a distance between each of the curves 301 of the second pattern 30 and the center point 11 is L, and the curvature c of each of the curves 301 and the distortion value σ satisfy a formula c=kLσ (formula (1)), where k is a constant.

In one embodiment, the curvatures of the curve 301 connecting the first point 31 and the third point 33 and the curve 301 connecting the first point 31 and the fourth point 34 are c1, the curvatures of the curve 301 connecting the second point 32 and the third point 33 and the curve 301 connecting the second point 32 and the fourth point 34 are c2. Since the distances between any point of the second pattern 30 and the center point 11 are different and the first point 31 is closer to the center point 11 than the second point 32, then c1<c2.

In one embodiment, a first imaginary line 361 connecting the third point 33 and the fourth point 34 and a second imaginary line 362 connecting the first point 31 and the second point 32 intersect at a fifth point 35. The fifth point 35 is located on the first diagonal line 12. The curve 301 connecting the first point 31 and the third point 33 and the curve 301 connecting the first point 31 and the fourth point 34 are convex relative to the fifth point 35. The curve 301 connecting the second point 32 and the third point 33 and the curve 301 connecting the second point 32 and the fourth point 34 are concave relative to the fifth point 35.

In this embodiment, the four first patterns 20 are located on a circle or ellipse with a center on the center point 11, the four second patterns 30 are located on another circle or ellipse with a center on the center point 11. The first point 31, the second point 32, the third point 33, the fourth point 34, and the fifth point 35 are respectively located on different circles or ellipses with the center on the center point 11.

In one embodiment, the second pattern 30 satisfies a formula L1>L2 (formula (2)), where L1 is a straight-line distance between the fifth point 35 and the second point 32, and L2 is a straight-line distance between the first point 31 and the fifth point 35.

In one embodiment, the first imaginary line 361 is perpendicular to the second imaginary line 362. The straight-line distances between the first point 31 and the fifth point 35, between the fifth point 35 and the third point 33, and between the fifth point 35 and the fourth point 34 are the same.

In one embodiment, on the first diagonal line 12, the first pattern 20 is closer to the center point 11 than the second pattern 30. The first pattern 20 is rectangular, preferably square, and a diagonal line of the first pattern 20 is overlapped with the first diagonal line 12 of the test area 10. As such, the first pattern 20 and the second pattern 30 have different shapes, which increases the diversity of patterns of the test chart 100 and is conducive to improving the test accuracy of the resolution of the wide-angle lens.

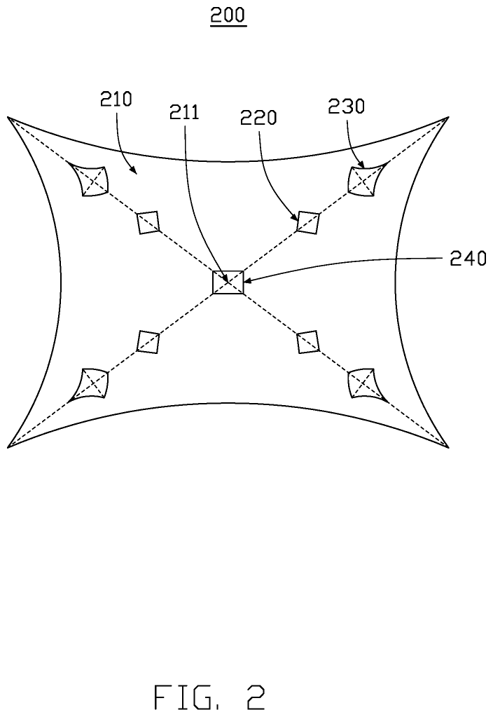

As shown in FIG. 2, a test chart 200 in another embodiment includes one third pattern 240. The third pattern 240 is rectangular, the center point of the third pattern 240 coincides with a center point 211 of a test area 210, and the diagonal lines of the third pattern 240 coincide with the diagonal lines of the test area 210. As such, the diversity of patterns of the test chart 200 is increased, which is beneficial to improving the test accuracy of the resolution of the wide-angle lens.

In other embodiments, the test chart 200 can include patterns with other shapes. For example, a rectangular pattern, preferably a square pattern, can be arranged between the center point 211 and any one of first patterns 220. A rectangular pattern, preferably a square pattern, can also be arranged between one first pattern 220 and one second pattern 230 on one diagonal line. A pattern, being axisymmetric with respect to the diagonal lines of the test area 210, formed by connecting four curves, can also be arranged between one first pattern 220 and one second pattern 230 on one diagonal line. The curvature of the curves of such pattern is less than that of the second pattern 230. A pattern, being axisymmetric with respect to the diagonal lines of the test area 210, formed by connecting four curves, can also be arranged on a side of one second pattern 230 away from one first pattern 220 on one diagonal line, and the curvature of the curves of such pattern is greater than that of the second pattern 230.

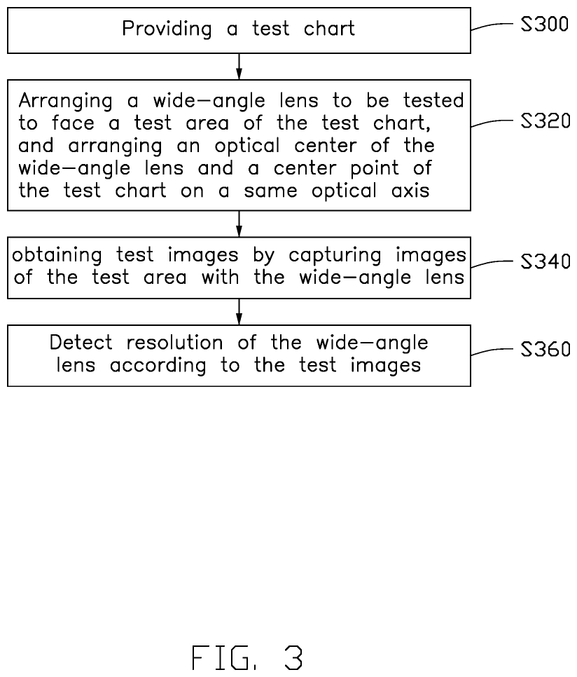

As shown in FIG. 3, a method for testing resolution of a wide-angle lens begins at block S300.

At block S300, a test chart of any one of the above embodiments of the present disclosure is provided. In this embodiment, the exemplary method refers to the test chart 100 including the test area 10, the first patterns 20, and the third patterns 30.

At block S320, a wide-angle lens to be tested is arranged to face the test area 10 of the test chart 100, and an optical center of the wide-angle lens and the center point 11 of the test chart 100 are arranged on a same optical axis. As such, the wide-angle lens can accurately capture images of the test chart 100, a test error caused by misalignment of the optical center and the center point 11 can be eliminated.

At block S340, test images are obtained by capturing images of the test area 10 with the wide-angle lens. During the capturing of images, the test area 10, the first patterns 20, and the second patterns 30 of the test area 10 are taken as effective areas for capturing.

At block S360, the resolution of the wide-angle lens is detected according to the test images.

In this embodiment, a field angle of the wide-angle lens is greater than or equal to 150 degrees.

In the method, the test chart 100 with the test area 10, the first patterns 20, and the second patterns 30 is the subject to be captured by the wide-angle lens to detect the resolution of the wide-angle lens, which can ensure the first and second patterns of the test chart in the captured images to be undeformed, improving the test accuracy of the resolution of the wide-angle lens.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appointed claims are expressed.

What is claimed is:

1. A test chart, for testing resolution of a wide-angle lens, comprising:
a test area having a center point, a first diagonal line, and a second diagonal line, the first diagonal line and the second diagonal line intersecting at the center point;
a plurality of first patterns arranged around the center point and located on the first diagonal line and the second diagonal line; and
a plurality of second patterns arranged around the center point and located on the first diagonal line and the second diagonal line;
wherein each of the plurality of second patterns is located on a side of one of the plurality of first patterns away from the center point;
wherein each of the plurality of second patterns comprises a first point, a second point, a third point, and a fourth point, the first point and the second point are located on the first diagonal line or the second diagonal line, the third point and the fourth point are located on opposite sides of the first diagonal line or the second diagonal line, the second point is located on a side of the first point away from the center point;
the first point, the third point, the second point, and the fourth point are successively connected by a plurality of curves with curvature positively related to a distortion value of the wide-angle lens.

2. The test chart of claim 1, wherein a first imaginary line connecting the third point and the fourth point and a second imaginary line connecting the first point and the second point intersect at a fifth point, one of the plurality of curves connecting the first point and the third point and one of the plurality of curves connecting the first point and the fourth point are convex relative to the fifth point, one of the plurality of curves connecting the second point and the third point and one of the plurality of curves connecting the second point and the fourth point are concave relative to the fifth point.

3. The test chart of claim 2, wherein each of the plurality of second patterns satisfies the following formula:
L1>L2;
wherein, L1 is a straight-line distance between the fifth point and the second point, and L2 is a straight-line distance between the first point and the fifth point.

4. The test chart of claim 3, wherein the first imaginary line is perpendicular to the second imaginary line.

5. The test chart of claim 4, wherein the straight-line distance between the first point and the fifth point, a straight-line distance between the fifth point and the third point, and a straight-line distance between the fifth point and the fourth point are the same.

6. The test chart of claim 1, wherein the test area is a quadrilateral in shape, and four sides of the quadrilateral are concave relative to the center point.

7. The test chart of claim 1, wherein each of the plurality of second patterns satisfies the following formula:
c1<c2;
wherein c1 is the curvature of one of the plurality of curves connecting the first point and the third point, and c2 is the curvature of one of the plurality of curves connecting the second point and the fourth point.

8. The test chart of claim 1, wherein the test chart comprises four first patterns and four second patterns, two of the four first patterns are arranged on the first diagonal line and take the center point as a point of symmetry, two of the four second patterns are arranged on the first diagonal line and take the center point as the point of symmetry, the other two of the four first patterns are arranged on the second diagonal line and take the center point as the point of symmetry, and the other two of the four second patterns are arranged on the second diagonal line and take the center point as the point of symmetry.

9. The test chart of claim 1, wherein each of the plurality of first patterns is rectangular, a diagonal line of each of the plurality of first patterns is overlapped with the first diagonal line or the second diagonal line.

10. A method for testing resolution of a wide-angle lens, comprising:
providing a test chart comprising a test area, a plurality of first patterns, and a plurality of second patterns, the test area having a center point, a first diagonal line, and a second diagonal line, the first diagonal line and the second diagonal line intersecting at the center point, the plurality of first patterns being arranged around the center point and located on the first diagonal line and the second diagonal line, the plurality of second patterns being arranged around the center point and located on the first diagonal line and the second diagonal line, wherein each of the plurality of second patterns is located on a side of one of the plurality of first patterns away from the center point, each of the plurality of second patterns comprises a first point, a second point, a third point, and a fourth point, the first point and the second point are located on the first diagonal line or the second diagonal line, the third point and the fourth point are located on opposite sides of the first diagonal line or the second diagonal line, the second point is located on a side of the first point away from the center point, the first point, the third point, the second point, and the fourth point are successively connected by a plurality of curves with curvature positively related to a distortion value of the wide-angle lens;
arranging the wide-angle lens to face the test area, and arranging an optical center of the wide-angle lens and the center point on a same optical axis;
obtaining test images by capturing images of the test area with the wide-angle lens;
detecting the resolution of the wide-angle lens according to the test images.

11. The method of claim 10, wherein a first imaginary line connecting the third point and the fourth point and a second imaginary line connecting the first point and the second point intersect at a fifth point, one of the plurality of curves connecting the first point and the third point and one of the plurality of curves connecting the first point and the fourth point are convex relative to the fifth point, one of the plurality of curves connecting the second point and the third point and one of the plurality of curves connecting the second point and the fourth point are concave relative to the fifth point.

12. The method of claim 11, wherein each of the plurality of second patterns satisfies the following formula:
L1>L2;
wherein, L1 is a straight-line distance between the fifth point and the second point, and L2 is a straight-line distance between the first point and the fifth point.

13. The method of claim 12, wherein the first imaginary line is perpendicular to the second imaginary line.

14. The method of claim 13, wherein the straight-line distance between the first point and the fifth point, a straight-line distance between the fifth point and the third point, and a straight-line distance between the fifth point and the fourth point are the same.

15. The method of claim 10, wherein the test area is a quadrilateral in shape, and four sides of the quadrilateral are concave relative to the center point.

16. The method of claim 10, wherein each of the plurality of second patterns satisfies the following formula:
c1<c2;
wherein c1 is the curvature of one of the plurality of curves connecting the first point and the third point, and c2 is the curvature of one of the plurality of curves connecting the second point and the fourth point.

17. The method of claim 10, wherein the test chart comprises four first patterns and four second patterns, two of the four first patterns are arranged on the first diagonal line and take the center point as a point of symmetry, two of the four second patterns are arranged on the first diagonal line and take the center point as the point of symmetry, the other two of the four first patterns are arranged on the second diagonal line and take the center point as the point of symmetry, and the other two of the four second patterns are arranged on the second diagonal line and take the center point as the point of symmetry.

18. The method of claim 10, wherein each of the plurality of first patterns is rectangular, a diagonal line of each of the plurality of first patterns is overlapped with the first diagonal line or the second diagonal line.
